(19) United States
(12) Patent Application Publication
(10) Pub. No.: US 2009/0225078 A1
(43) Pub. Date: Sep. 10, 2009

(54) Rendering Curves Through Iterative Refinement

(76) Inventors: Jaroslaw Roman Rossignac, Atlanta, GA (US); Scott David Schaefer, Bryan, TX (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/399,829

(22) Filed: Mar. 6, 2009

Related U.S. Application Data
(60) Provisional application No. 61/034,712, filed on Mar. 7, 2008.

(51) Int. Cl. G06T 17/20

(52) U.S. Cl. 345/423

(57) ABSTRACT

Systems and methods of rendering curves through iterative refinement are disclosed. One such method of rendering a curve from a polygonal control loop ⁰P comprises iteratively applying k subdivisions described by Jₛ to a series of polygons starting with ⁰P, where each subdivision is applied to the previous polygon.

### CROSS REFERENCE TO RELATED APPLICATIONS

This application claims priority to copending U.S. Provisional Application having Ser. No. 61/034,712 filed Mar. 7, 2008, which is hereby incorporated by reference herein in its entirety.

### FIELD OF THE DISCLOSURE

The present disclosure relates to computer graphics, and more specifically, to rendering curves.

### BACKGROUND

Rendering of two-dimensional curves and three-dimensional surfaces can be performed with an iterative process known as subdivision. Subdivision starts with an initial control polygon, and in each iteration, replaces each vertex with two vertices. Many types of subdivision schemes are possible.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1A shows an example of closed loop polygonal curves created in accordance with some subdivision embodiments disclosed herein;

FIG. 1B is an enlarged view of particular points generated by the first iteration of FIG. 1;

FIGS. 2A-2C show the curves resulting from various numbers of iterations of particular variations of J_{S} in accordance with some subdivision embodiments disclosed herein;

FIGS. 3A-C illustrates subdivisions of various J_{S} curves using different initial polygonal loops in accordance with some subdivision embodiments disclosed herein;

FIG. 4 illustrates various J_{S} curves that approximate different B curves in accordance with some subdivision embodiments disclosed herein;

FIGS. 5A-5D illustrate stages in an iterative retrofitting process in accordance with some subdivision embodiments disclosed herein;

FIGS. 6A-5D illustrate curves produced an iterative retrofitting process as applied to various control loops, in accordance with some subdivision embodiments disclosed herein;

FIGS. 7A-5D illustrate curves produced by a mixed-scheme variation in accordance with some subdivision embodiments disclosed herein;

FIGS. 8A-D illustrate curves produced by another mixed-scheme variation in accordance with some subdivision embodiments disclosed herein;

FIGS. 9A-9D illustrates comparative results of several approaches to edge interpolation:

FIGS. 10A-10F illustrate the results of various parameter adjustments to preserve two-dimensional area, in accordance with some subdivision embodiments disclosed herein

FIGS. 11A-11J illustrate the results of an optimization to match linear subdivision, in accordance with some subdivision embodiments disclosed herein

FIGS. 12A-12D illustrate the curves produced by a multi-resolution variation of some subdivision embodiments disclosed herein;

FIGS. 13A-13F illustrate the curves produced by an open-curve variation of some subdivision embodiments disclosed herein;

FIG. 14 illustrates stages of a ringing method used to implement some of the subdivision embodiments described herein.

FIGS. 15A-15L illustrate various surfaces produced by an animation variation of some subdivision embodiments disclosed herein; and

FIGS. 16A-16L illustrate various surfaces with borders that are produced by an animation variation of some subdivision embodiments disclosed herein.

### DETAILED DESCRIPTION

### Curve Refinements

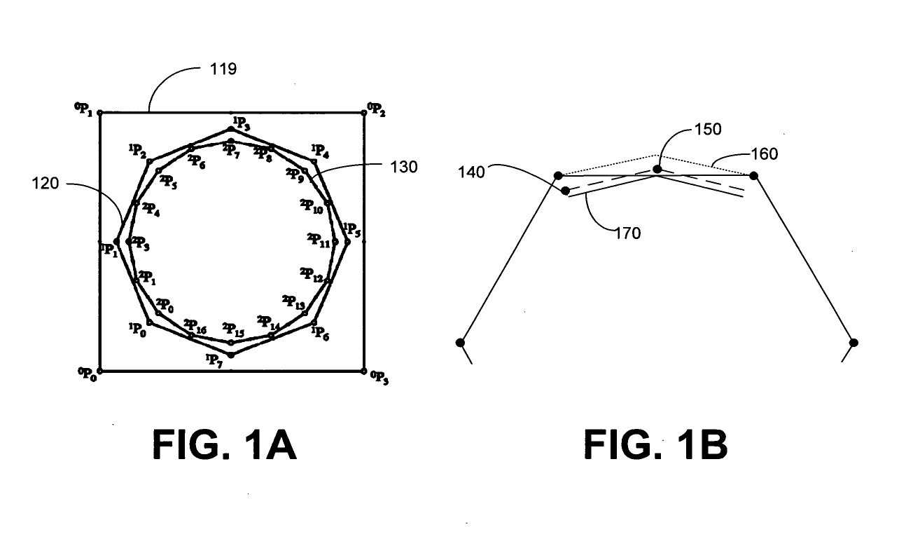

One type of subdivision is known as split and tweak. Starting with an initial polygonal control loop, a Split operation inserts a new mid-edge vertex in the middle of each edge and then a Tweak operation adjusts the position of the old and/or new vertices. In this disclosure, we refer to the initial polygonal control loop as ⁰P, the loop obtained after k subdivision steps (Split and Tweak pairs) as ^{k}P, the jth vertex of ^{k}P as ^{k}Pⱼ. The subdivision scheme disclosed herein computes each new vertex of ^{k+1}P as a linear combination of a set of vertices of ^{k}P. Specifically, the new position of the old vertices is ^{k+1}P₂ⱼ=α^{k}Pⱼ₋₁+β^{k}Pⱼ+X^{k}Pⱼ₊₁, and the position the mid-edge vertices created by the split is ^{k+1}P₂ⱼ+1=δ^{k}Pⱼ₋₁+ε^{k}Pⱼ+φ^{k}Pⱼ₊₁+γ^{k}Pⱼ₊₂ for the position of the mid-edge vertices created by the split. All operations on vertex indices are performed modulo the number of vertices in the loop. FIG. 1A shows an example of closed loop polygonal curves created by three iterations: an initial control polygon ⁰P (110); ¹P (120) created by the first subdivision; and ²P (130) created by the second subdivision. FIG. 1B is an enlarged view of particular points generated by the first iteration: point 140 is α⁰P₁+β⁰P₂+X⁰P₃; and point 150 is δ⁰P₁+ε⁰P₂+φ⁰P₃+γ⁰P₄. These two points lie between the corresponding vertices produced by the four-point subdivision scheme (160) and those produced by the uniform cubic B-spline subdivision scheme (170). This particular interpolation corresponds to J_{0.7}.

To achieve a symmetric scheme for which the result is independent of the orientation of the control loop, α=X, δ=γ, and ε=φ. To make the subdivision scheme translation-invariant, the relationship between the coefficients is α+β+X=1 and δ+ε+φ+γ=1. Hence, all seven coefficients may be defined in terms of two parameters, a and b. In one example embodiment disclosed herein, the relationship between the two parameters and the seven coefficients is α=X=a/8, β=(8−2a)/8, δ=γ=(b−1)/16, and ε=φ=(9−b)/16. The corresponding subdivision, ^{k+1}P₂ⱼ=(a^{k}Pⱼ₋₁+(8−2a)^{k}Pⱼ+a^{k}Pⱼ₊₁)/8 and ^{k+1}P2ⱼ₊₁=((b−1)^{k}Pⱼ₋₁+(9−b)^{k}Pⱼ+(9−b)^{k}Pⱼ₊₁+(b−1)^{k}Pⱼ₊₂)/16, is denoted J_{a,b}. For simplicity, J_{s,s} is referred to herein as Jₛ.

This particular parameterization has the property that J₀ is the four-point subdivision and J₁ is the uniform cubic b-spline subdivision (see FIG. 1A). Also note that J_{1/2} is the Jarek subdivision, which averages the four-point and the cubic b-spline subdivisions, and usually nearly preserves the area enclosed by a 2D curve. The result ^{k}P of applying Jₛ refinements k times to ⁰P is denoted herein as ^{k}Jₛ (⁰P).

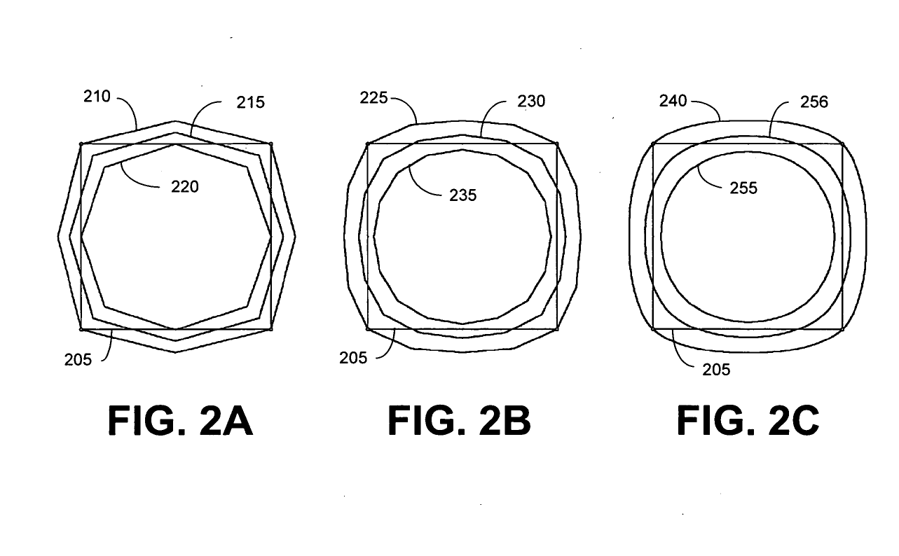

FIGS. 2A-2C show the curves resulting from various numbers of iterations of particular variations of Jₛ. FIG. 2A shows the results of a single subdivision: polygon 205 is the initial polygon; polygon 210 is the result of one J⁰ (four-point) subdivision; polygon 215 is the result of one J_{1/2} (Jarek) subdivision; polygon 220 is the result of one J₁ (uniform cubic b-spline) subdivision. FIG. 2B shows the results of two subdivisions: polygon 205 is the initial polygon; polygon 225 is the result of two J⁰ (four-point) subdivisions; polygon 230 is the result of two J_{1/2} (Jarek) subdivisions; polygon 235 is the result of two J₁ (uniform cubic b-spline) subdivisions. FIG. 2C shows the results of six subdivisions: polygon 205 is the initial polygon; polygon 240 is the result of six J⁰ (four-point) subdivisions; polygon 245 is the result of six J_{1/2} (Jarek) subdivisions; polygon 250 is the result of six J₁ (uniform cubic b-spline) subdivisions.

The above discussion showed how curve subdivision schemes can be parameterized. Using the techniques disclosed herein, these parameters can be optimized to achieve geometric properties such as vertex or mid-edge point interpolation or area preservation. In some embodiments, the optimal parameters are chosen independent of any data given, which reduces or eliminates the optimization cost and ensures stability and local control.

### Continuity of the Jₛ Family

The Jₛ subdivision scheme, as disclosed herein, generalizes the Jarek construction to the whole family of subdivision schemes. Consider two loops, P={P₀, P₁, . . . Pₖ} and Q={Q₀, Q₁, . . . Qₖ}. Let Lₛ(P,Q) produce a new loop R={R₀, R₁, . . . Rₖ}, where Rᵢ=(1−s)Pᵢ+sQᵢ. Note that although Jₛ(⁰P)=Lₛ(J₀(⁰P), J₁(⁰P)), in general, ^{k}Jₛ(⁰P)≠Lₛ(^{k}J₀(⁰P), ^{k}J₁(⁰P)). Hence, the curves produced by iterations of Jₛ refinements are not linear combinations of the curves produced by iterations of four-point and cubic B-spline schemes. This observation explains why the limit curves produced by iterative Jₛ refinements exhibit superior smoothness properties. As the number k of refinements grows, the loop ^{k}P converges to a limit curve *Jₛ(⁰P), which we simply denote as *Jₛ.

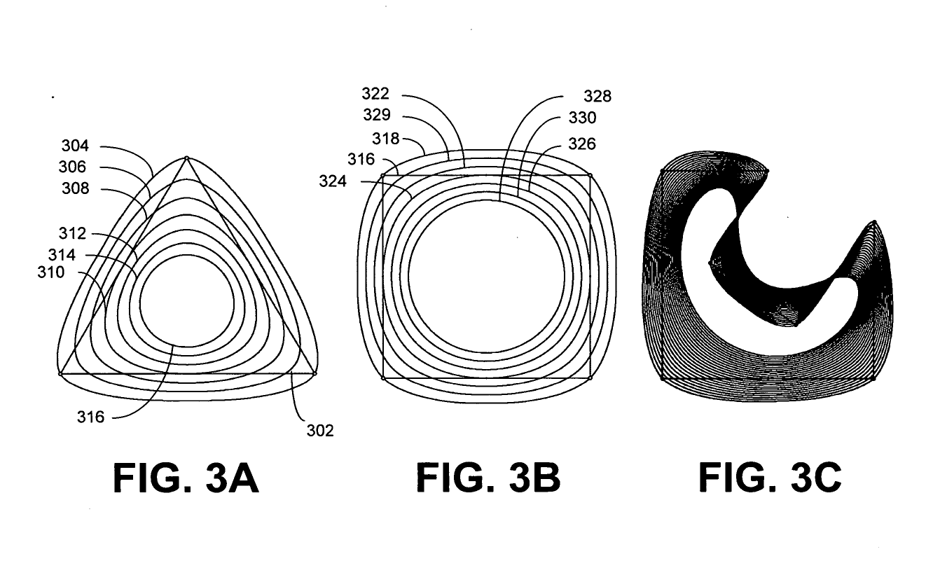

This convergence is illustrated in FIGS. 3A-3C. FIG. 3A illustrates five subdivisions of various Jₛ curves when the initial polygonal loop is triangle 302: polygonal curve ⁵J₀ (304); polygonal curve ⁵J_{2/8} (306); polygonal curve ⁵J_{4/8} (308); polygonal curve ⁵J_{6/8} (308); polygonal curve ⁵J_{8/8} (310); polygonal curve ⁵J_{10/8} (312); and polygonal curve ⁵J_{12/8} (314). In a similar manner, FIG. 3B illustrates five subdivisions of various Jₛ curves when the initial polygonal loop is square 316: polygonal curve ⁵J₀ (318); polygonal curve ⁵J_{2/8} (320); polygonal curve ⁵J_{4/8} (322); polygonal curve ⁵J_{6/8} (324); polygonal curve ⁵J_{8/8} (326); polygonal curve ⁵J_{10/8} (328); and polygonal curve ⁵J_{12/8} (330). FIG. 3C illustrates an even denser sampling of *Jₛ curves. Note that *J₀ is the C¹ four-point curve (304, 318). *J_{4/8} is the C² Jarek curve (308, 322). *J_{8/8} is the C² uniform cubic B-spline curve (310, 326). *J_{12/8} is the C⁴ quintic uniform B-spline curve (314, 330).

We show that: for −1.7≦s<0 and 4≦s≦5.8, *Jₛ is C¹; for 0<s≦1 and 2.8<s<4, *Jₛ is C²; for 1<s<3/2 and 3/2<s≦2.8, *Jₛ is C³; for s=3/2, *Jₛ is C^{4ef}. To establish the continuity of the Jₛ scheme for different values of s, we first consider the necessary conditions for continuity. Given the subdivision matrix for Jₛ, if the subdivision scheme produces curves that are C^{m}, then the eigenvalues of its subdivision matrix are of the form 1, (1/2), (1/4), . . . , (1/2)^{m}, λ, . . . where λ<(1/2)^{m}. The eigenvalues of the subdivision matrix for Jₛ subdivision are 1, (1/2), (1/4), (1/8), (2−s)/8, (s−1)/16, (s−1)/16, 0, 0. It is easy to verify that Jₛ subdivision satisfies the necessary conditions for C¹ continuity when −2<s<6, for C² continuity when 0<s<4, for C³ continuity when 1<s<3, and for C⁴ continuity when s=3/2. Notice that these conditions are only necessary, they are not sufficient.

To determine sufficient conditions on the subdivision scheme, the Laurent polynomial of the subdivision scheme is used, given by S(z)=(s−1)/16+s/8z+(9−s)/16z²+(1−s/4)z³+(9−s)/16z⁴+s/8z⁵+(s−1)/16z⁶, which encodes the columns of the infinite subdivision matrix in a compact form. The subdivision scheme will generate C^{m} curves if the infinity norm of the kth power of the subdivision matrix for the mth divided differences is less than 1 for some k. The columns of this divided difference subdivision matrix are given by (2^{m}/(1+z)^{m+1})S(z). A numeric check of what range of s satisfies these bounds for different continuity levels verifies that Jₛ subdivision produces curves that are at least C¹ for −1.7<=s<=5.8, at least C² for 0<s<4, at least C³ for 1<s<=2.8, and at least C⁴ for s=3/2. In fact, s=3/2 corresponds to uniform quintic b-spline subdivision, which is easily verified by noticing that their Laurant polynomials are identical. Although the numerically verified sufficient bounds are slightly more restrictive than the proven necessary bounds, the true sufficient bounds are strongly suspected to extend to match the necessary bounds for continuity in the limit. However, the numerical verification is exponential in k and difficult to compute for large values of k.

Relation with Uniform B-Splines

Uniform B-spline curves B_{d} of degree d have a two-part subdivision: first the control points are doubled by inserting mid-edge points; then we replace the vertices by the mid-edge points d−1 times. This subdivision scheme creates curves that are C^{d-1}. The Jₛ subdivision scheme described herein exactly reproduces the odd degree B-splines B₃ and B₅ for s=1 and s=3/2, but not even degree B-splines. However, in some embodiments, parameter s is optimized in a data independent manner to match the basis functions created by B2 and B4 subdivision.

In one embodiment this optimization is performed by minimizing the difference between the basis function values on a dense uniform grid. The optimal parameter s depends on what norm is used to measure the distance between the values. One such norm is L₂ but this norm has little to do with how humans perceive closeness. The L_{∞} norm may be the best norm because this norm minimizes the worst-case scenario and provides strict error bounds. The disadvantage of the L∞ norm is that the optimization problem becomes difficult due to the use of non-differentiable functions like Max and Abs. On the other hand, the L₁ norm optimizes the average case scenario and will typically perform better in practice than other norms, but this norm does not bound the worst case as the L_{∞} norm does.

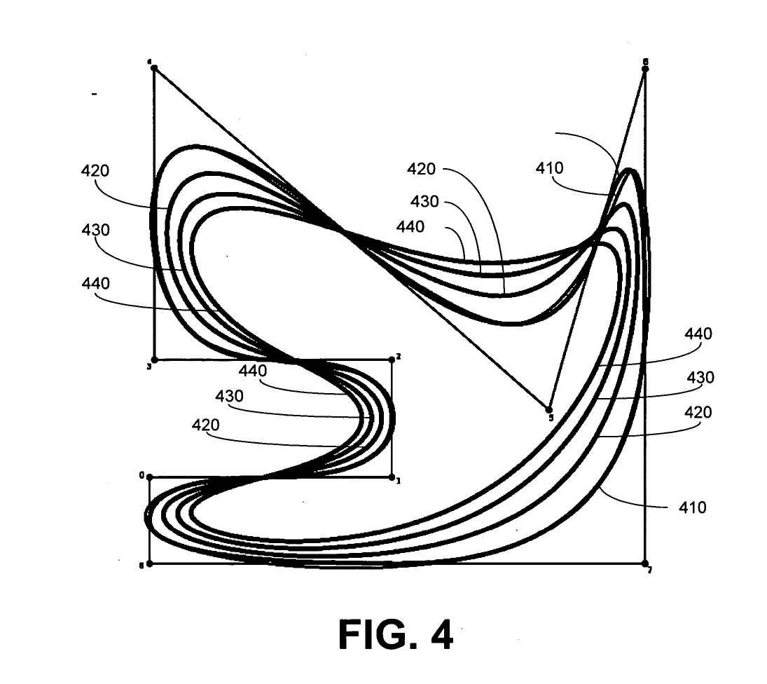

In some of the embodiments described herein, the optimal parameter in these different norms is computed even if the computation requires significant effort, since the optimization is data independent and only needs to be computed once. When optimizing the Jₛ subdivision scheme described herein to match quadratic B-spline subdivision, the L1 and L∞ norms produce very different values s=0.689 and s=0.639 respectively. In some embodiments, the L₁ norm is selected as it is expected to perform better in practice. For quartic B-splines, the two norms are very close to one another and the optimal value is computed as s=1.27. Notice that quadratic B-splines are actually C¹ curves, whereas a J_{0.689} subdivision scheme as disclosed herein approximates quadratic B-splines actually produces C² curves. J_{8/8} converges to a cubic B-spline curve B₃. J_{1.27} converges to a C³ curve that closely approximates the quartic B-spline curve B₄. Finally, J_{12/8} converges to a C₄ quintic B-spline curve. FIG. 4 illustrates various J_{S} curves: *J_{0.689} (410) approximates B₂; *J₁ (420) is B₃; *J_{1.27} (430) approximates B₄; *J_{1.5} (440) is B₅. To facilitate comparison, the J curves are superimposed on top of their thicker black B-spline counterparts.

### A Retrofitting Variation

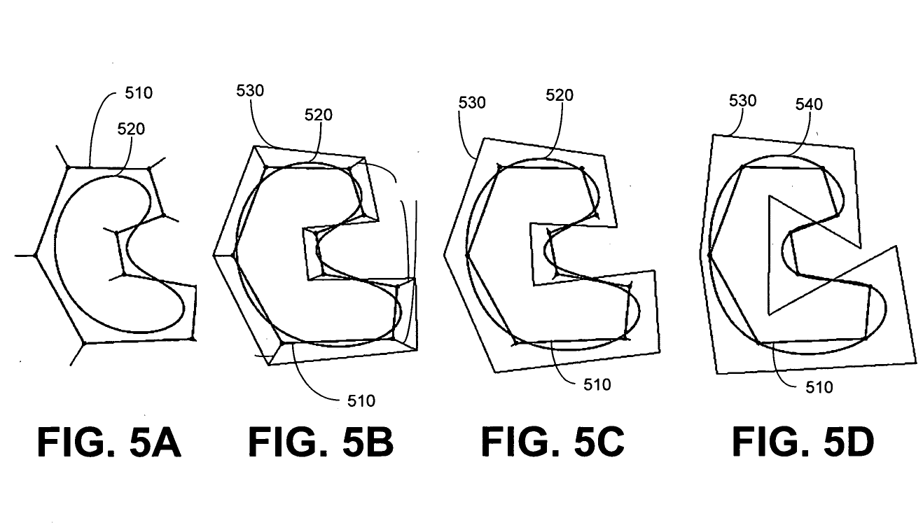

As the value of s increases towards 1.5, the smoothness of the Jₛ curve described herein increases, but the limit curve drifts farther away from the vertices of the original control loop C. In some embodiments, an optimization is used to obtain a polygon loop ⁰P for which the limit curve *P exactly interpolates the vertices of C. In general, the limit mask for the Jₛ subdivision is given by the dominant left eigenvector of the subdivision matrix and has the closed-form {(s−1)s, 2s(8−s), 72+2(s−9)s, 2s(8−s), (s−1)s}/(12(6+s)) for arbitrary parameter values s. One variation finds control points whose limit curve exactly interpolates the vertices of the control polygon by solving a global system of equations using a matrix whose rows contain shifts of the limit mask. Another variation uses an iterative retrofitting which can quickly converge to the solution of these equations. FIGS. 5A-5D illustrate the iterative retrofitting process. As shown in FIG. 5A; initial control polygon ⁰P (510) is initialized with the vertices of C and, for each vertex ⁰Pⱼ, its limit position *Pⱼ (520) is computed using the limit mask provided above. In FIG. 5B, polygon 520 is produced by adjusting each vertex ⁰Pⱼ to ⁰Pⱼ+(Cⱼ−*Pⱼ). As shown in FIG. 5C, this process is iterated to until the difference between *Pⱼ and Cⱼ for all j falls below a desired threshold to converge on a new control polygon 530. The final result is shown is interpolating curve 540 of FIG. 5D.

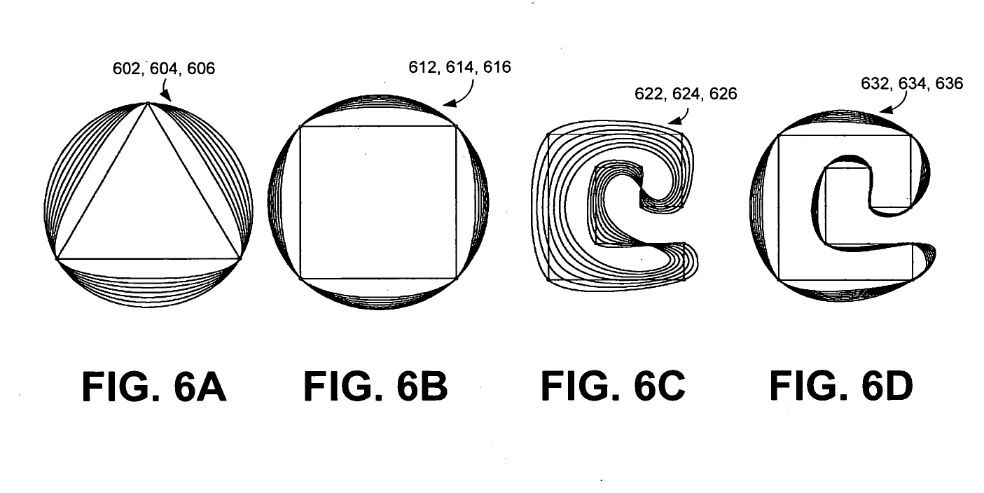

FIGS. 6A-6D illustrate retrofitting as applied to other shapes: FIG. 6A illustrates retrofitting iterations (e.g., 602, 604, 606) applied to a triangle; FIG. 6B illustrates retrofitting iterations (e.g., 612, 614, 616) applied to a square; FIG. 6C illustrates subdivision iterations (e.g., 622, 624, 626) applied to another shape, without retrofitting; FIG. 6D illustrates retrofitting iterations (e.g., 632, 634, 636) applied to the same shape from FIG. 6C.

The retrofitting method can be shown to fail to converge for some ranges of s values. We do so by computing the spectral radius (largest absolute eigenvalue) of the infinite matrix (I−L) where I is the identity matrix and L is a matrix whose rows contains shifts of the limit mask. Despite the fact that this matrix is infinite, we can use techniques from block-circulant matrices to write down the infinite set of eigenvalues and bound their norm. If the spectral radius of the matrix (I−L) is greater than or equal to 1, then this iterative method for interpolating the vertices of the control polygon will fail. For the subdivision scheme described herein, this convergence criteria is violated for s≦−0.86 and 2≦s. Therefore, this iterative retrofitting method will not work for these values of s. For −0.86<s<2 this retrofitting technique work well and converged quickly for various test cases during interactive curve manipulation.

### A Mixed-Scheme Variation

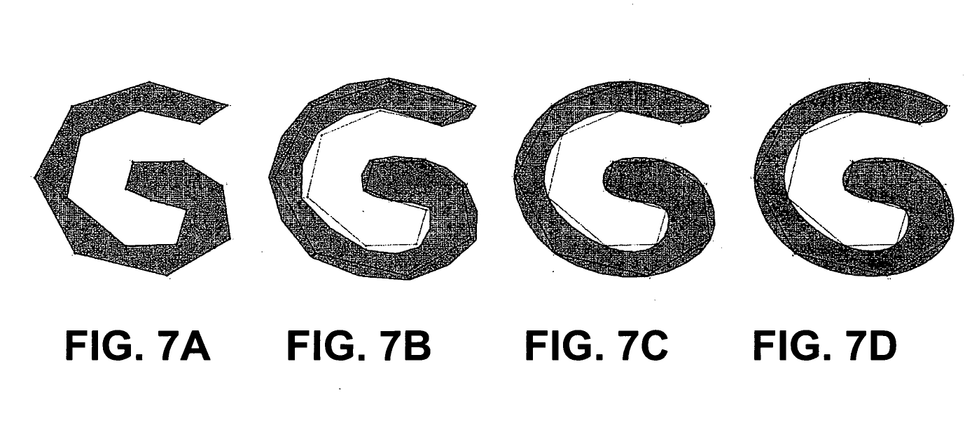

The retrofitting technique described above loses the local control property of the Jₛ subdivision technique, such that each control vertex of C may influence the entire curve *Jₛ. Another embodiment retains local control while producing subdivided curves that nearly interpolate the vertices of C, by combining Jₛ steps with different values of s. For example, a single anticipation Jᵣ step, with r=−33/26, followed by a series of J_{12/8} steps converges to a C⁴ quintic B-spline curve that nearly interpolates the original vertices. This is shown in FIGS. 7A-7D: FIG. 7A illustrates the original polygon control loop; FIG. 7B illustrates the curve produced by an “anticipation” step of Jᵣ with r=−33/26; FIG. 7C illustrates the resulting curve after a subsequent step J_{12/8}; finally, FIG. 7D shows the result of subsequent iterations of J₁₂/8 converging to a C⁴ curve close to the original vertices.

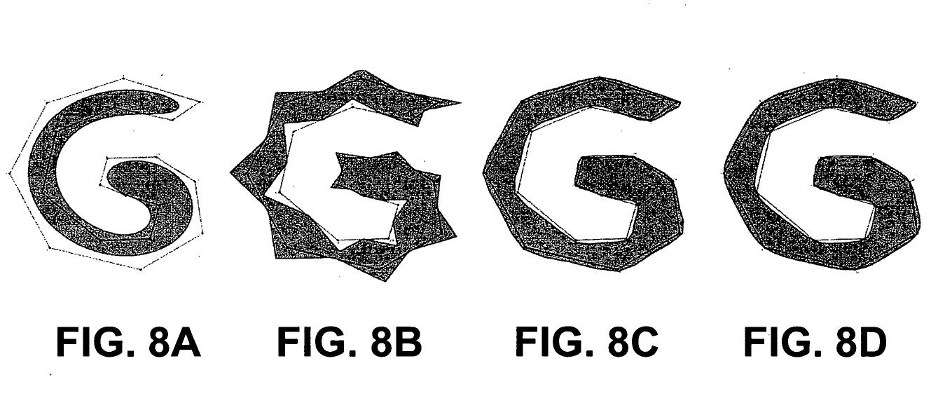

FIGS. 8A-D illustrate a variation which produces exact interpolation of the vertices: start with *J_{12/8} (FIG. 8A); follow with J_{a,b}, where a=−7/4 and b=59/52 (FIG. 8B); followed by another J_{12/8} (FIG. 8C); followed by several additional J_{12/8}.where a=−7/4 and b=59/52. Note that the final shape (FIG. 8D) is somewhat flattened along the edges

In the embodiments shown in FIG. 7A-D, as well as FIGS. 8A-D, these parameters are solved for by minimizing the difference between the limit masks of the modified curves and the identity mask yielding results independent of a particular shape.

### A Mid-Edge Interpolation Variation

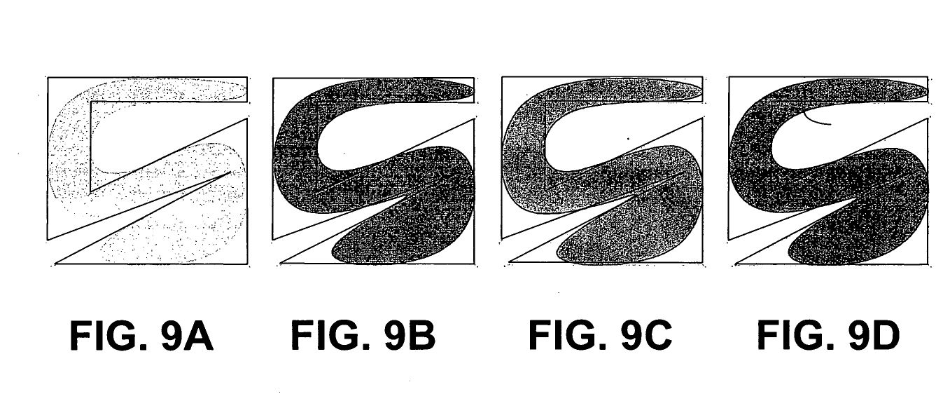

Instead of interpolating the original control vertices as discussed above, another variation interpolates mid-edge points. FIGS. 9A-9D shows comparative results of several approaches to edge interpolation: FIG. 9A is the C¹ quadratic B-spline B₂ curve; FIG. 9B is the C² curve produced using a J_{2/3} followed by a series of J₁ steps; FIG. 9C is the C²*Jₛ with s=0.751; and FIG. 9D is the C⁴ curve produced using a J_{29/59}, followed by a series of J_{12/8} steps. Note that the first two schemes interpolate the mid-edge points exactly, while the other two only pass very close to them. As before, these parameters are derived by minimizing the difference between the edge limit mask and the midpoint mask in the infinity norm.

### Application to Area Preservation in 2-D

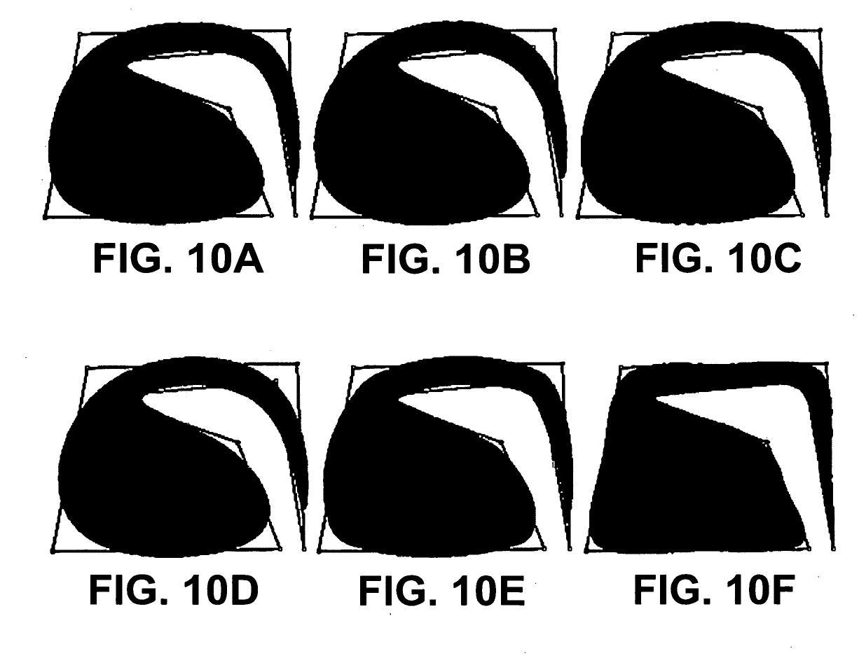

The Jₛ subdivision scheme disclosed herein can be applied to two-dimensional area preservation. For each polygonal control loop, the a, b, and s parameters may be adjusted in a shape-dependent manner through numerical iteration to ensure that the refined curve has the same area as the initial polygonal loop ⁰P. FIGS. 10A-10F show the results of various parameter adjustments, where E is the relative area error. FIG. 10A shows the C² curve produced by *J_{0.476}. FIG. 10B shows the C⁴ curve produced by *J_{0.050} followed by *J_{1.5}. The embodiments of FIG. 10A and FIG. 10B both yield E=0. FIG. 10C shows the curve produced by model-independent optimized approximation through *J_{0.46415}. with E=0.00786%. FIG. 10D shows the curve produced by model-independent optimized approximation through J_{-0.0299} followed by *J_{1.5}, which yields E=0.03443%. FIG. 10E shows the curve produced by model-independent optimized approximation through *J_{0.836} followed by *J_{-0.531}, which yields E=0.00014%. Finally, FIG. 10F shows the curve produced by model-independent optimized approximation through J_{0.0053, 1.0276} followed by **J_{0.4666}, which has exactly the same area as the control polygon independent of what control points are chosen. As before, these parameter values are derived by minimizing the difference between the exact inner product of the Jₛ scheme and linear subdivision in the infinity norm.

Note that these solutions are independent of the particular control polygon, but do not guarantee that area will be preserved exactly. If exact area preservation is required with a model-independent solution, a step of J_{-0.0053, 1.0276} followed by *J_{0.4666}, produces a C² curve that has the same area as the original control polygon, but the curve is noticeably flat along the edges of the control polygon.

### Application to Popping Reduction in Multi-Resolution Rendering

The Js subdivision scheme disclosed herein can be applied to multi-resolution rendering. The s parameter in Jₛ can be optimized to match linear subdivision, to produce a smooth curve that reduces the difference between consecutive levels of subdivision. A large discrepancy exists between optimal values in different norms: L_{∞} yields s=0.152773 whereas L₁ yields s=0.304763. The L₁ norm may perform better for most applications, although the result may depend on the particular control loop.

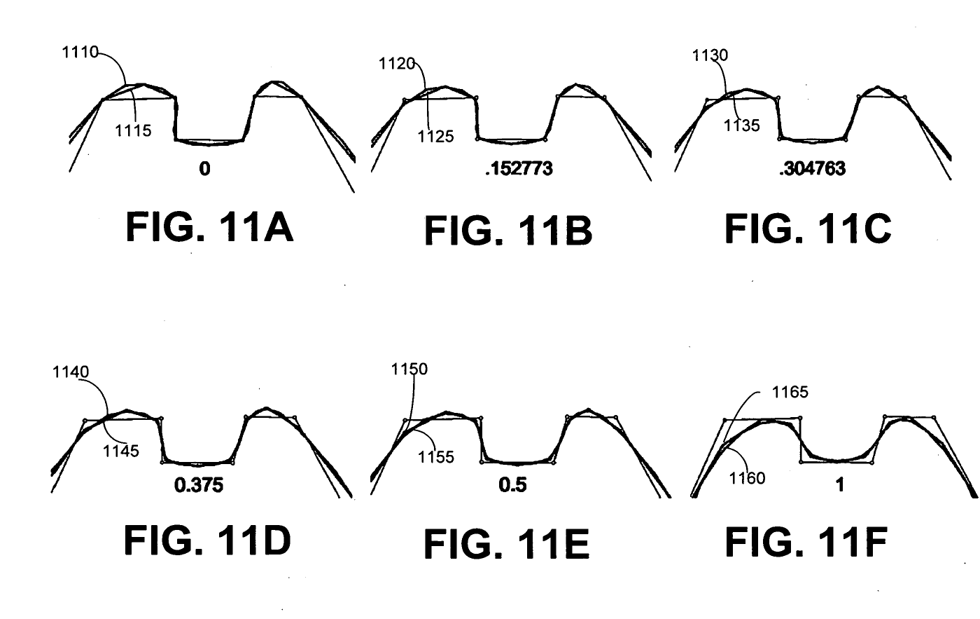

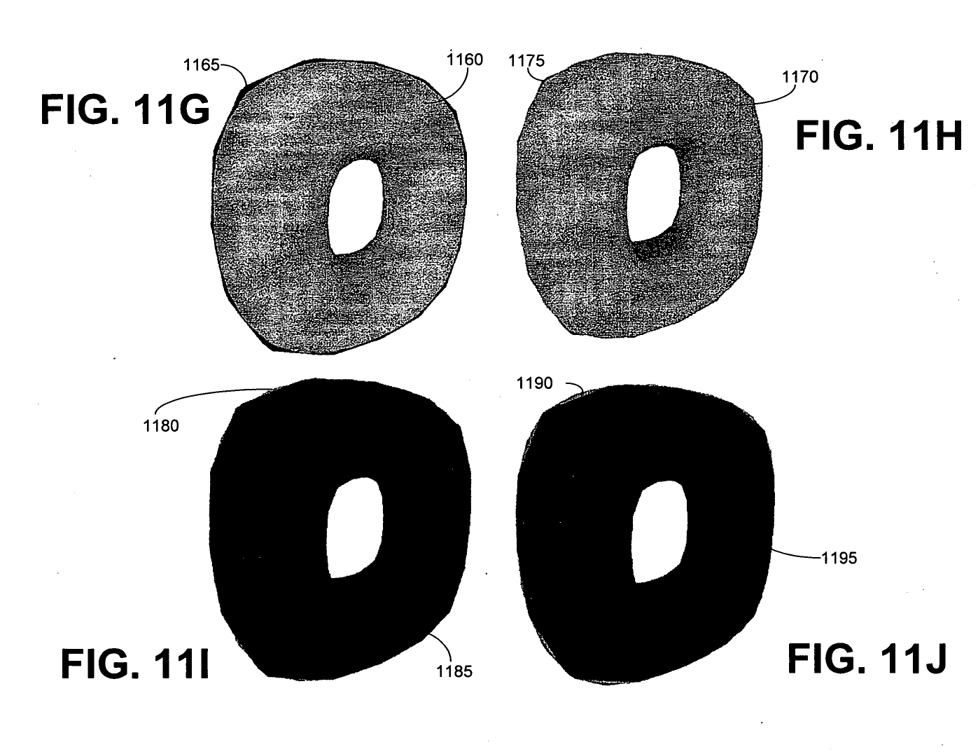

FIGS. 11A-11F show this optimization for various values of s: FIG. 11A shows the optimized curve 1110 for J₀, as well as the previous subdivision 1115; FIG. 11B shows the optimized curve 1120 for J_{0.152773}, as well as the previous subdivision 1125. FIG. 11C shows the optimized curve 1130 for J_{0.304763}, as well as the previous subdivision 1135. FIG. 11E shows the optimized curve 1140 for J_{0.375}, as well as the previous subdivision 1145. FIG. 11F shows the optimized curve 1150 for J_{0.5}, as well as the previous subdivision 1155. FIG. 11G shows the optimized curve 1160 for J₁, as well as the previous subdivision 1165. FIGS. 11G-11J show the previous subdivision with images superimposed to shown silhouette disparities, for J₀ (FIG. 11G), J_{3/8} (FIGS. 11H and 11I), and J₁ (FIG. 11J).

### Applications to Multi-Resolution Design

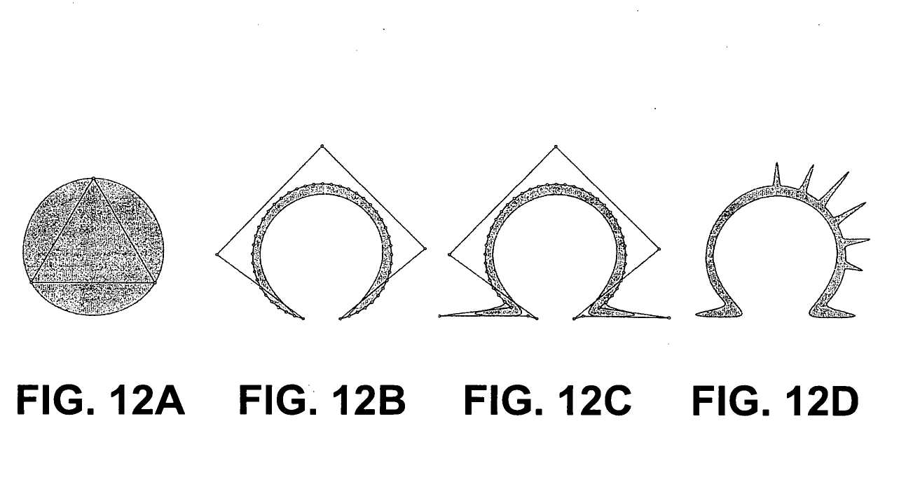

The Jₛ subdivision scheme disclosed herein can be applied to multi-resolution design. In one embodiment, the subdivisions are used as in Hierarchical B-splines to first define a smooth curve with very few control points. Then small details are added by editing the position of user-selected vertices at intermediate subdivision levels. Finally, subsequent levels of subdivision are performed. An example is shown in FIGS. 12A-12D: In FIG. 12A, three control points are used to create a disk using a J_{12/8} retrofit subdivision. In FIG. 12B, the three bottom vertices of an intermediate subdivision are displaced to create a cavity. In FIG. 12C, two other vertices are displaced to bend the ends into an omega shape. In FIG. 12D, six vertices of a further subdivision are pulled to add six spikes before further subdivisions. The resulting final shape is completely specified by only 14 control vertices.

### Extension to Open Curves

The Jₛ subdivision scheme disclosed herein can be extended to open curves by inserting four additional control points between ⁰P₀ and ⁰Pₙ₋₁ and by omitting 5 spans. The additional control points control the behavior of the limit curve near its ends. In some embodiments, the limit curve interpolates (in position and direction) both ends of the original control polygon: that is, the curve starts at ⁰P₀ with a tangent along ⁰P₁-⁰P₀ and to end at ⁰Pₙ₋₁ with a tangent along ⁰Pₙ₋₂-⁰Pₙ₋₁. Using the limit mask described above in connection with retrofitting, and the tangent mask {1−s,2(s−4),0,−2(s−4),−(1−s)}/12 derived from the left eigenvector of the subdivision matrix corresponding to 1/2, a simple set of equations is solved for these two additional control points to enforce these specified conditions. The solution adds two control points ⁰P₋₁=(9−s)/4⁰P₀+(s−3)/2⁰P₁+(1−s)/4⁰P₂ and ⁰P₋₂=(12−s)/2⁰P₀+(s−8)⁰P₁+(6−s)/2⁰P₂ to the curve. The masks for the opposite end of the curve are identical.

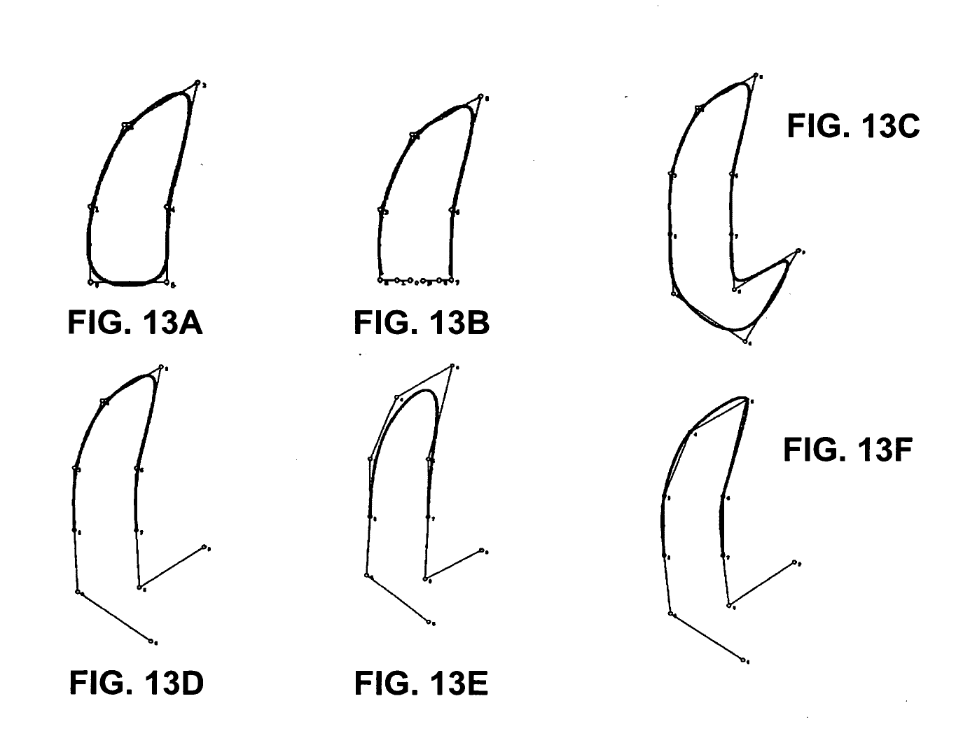

FIGS. 13A-13F illustrates this process: FIG. 13A is the *J_{0.5} closed loop; FIG. 13B is the loop with 4 vertices added between ⁰P₅ and ⁰P₀ and 5 spans removed; FIG. 13C is the loop as a closed loop with the 4 new vertices adjusted; FIG. 13D is the loop with 5 spans removed; FIG. 13E is the loop with different adjustments for *J₀; and FIG. 13F is the loop for *J_{1.5}.

### Ringing

A naïve Split & Tweak implementation of the Jₛ subdivision scheme disclosed herein would involve storing all the points of the final curve, or at least on the penultimate curve. Such a large amount of storage may be undesired when displaying surfaces or animations with a large numbers of recursions, or when the refinements are performed on graphics hardware with limited on-chip memory. Discussed next is an technique for generating a final curve without having to store the intermediate levels of subdivision and without having to perform any redundant computation.

This method—referred to herein as “ringing”—uses a ring data structure containing 5 points per subdivision level L. At any given moment during the curve rendering process, ring rₖ contains 5 consecutive points of ^{k}P. In one embodiment, rₖ is implemented as a first-in-first-out data structure. During curve rendering, the ring data structure rₖ advances along the polygon ^{k}P, one vertex at a time, to include the next vertex with each slide. Each ring stores its point in an array of 5 slots. To avoid shifting points, the index is advanced to the next-to-be-replaced vertex using modulo 5. The advancement of rings is synchronized, so that ring rₖ₊₁ advances twice as fast than ring rₖ. The top ring, r₀, obtains its next point as the next point along ⁰P. Each other ring rₖ₊₁, for k≧0, computes its next point from rₖ, alternating the two Jₛ masks: k+¹P₂ⱼ=(a^{k}P^{j-1}+(8−2a)^{k}Pⱼ+a^{k}Pⱼ₊₁)/8 for each even point and ^{k+1}P₂ⱼ₊₁=((b−1)^{k}Pⱼ₋₁+(9−b)^{k}P^{j}+(9−b)^{k}P^{j+1}+(b−1) ^{k}P^{j+2})/16 for each odd point. (These masks were introduced earlier in the discussion of FIG. 1.)

The ringing process begins by initializing the top ring r₀ with the first 5 control points of ⁰P. The points of the other rings, r₁, r₂, . . . r_{L}, are derived recursively using the two refinement formulae above. Then, the bottom ring r_{L} is advanced one step at a time, sliding at each step its 5 points by one vertex, along the final curve. For every 2 steps of rₖ the parent ring rₖ₋₁ makes one step. Ring r₀ is advanced by loading it with the next control point on the curve.

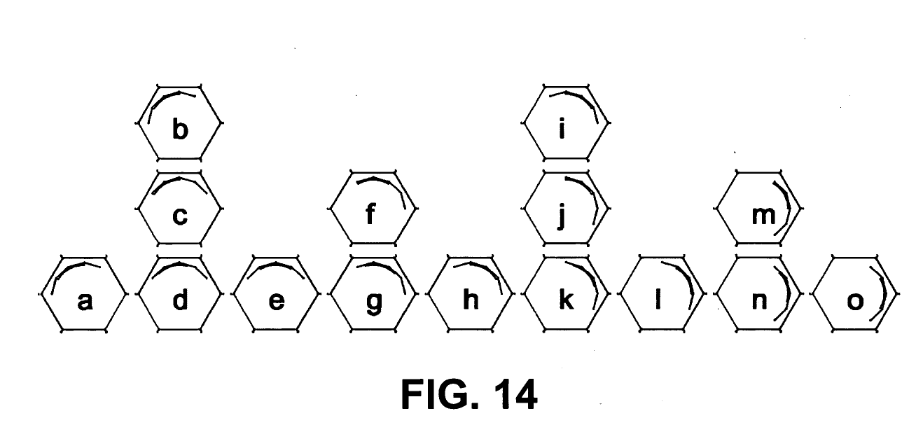

The stages of the ringing process are illustrated in FIG. 14. Stage (a) is initialization: r₀ is loaded with the first 5 control vertices; points of r₁ are derived from points in r₀; and points of r₂ are derived from points in r₁ using helper functions, b1, f12, b2, f23, b3, (found in the code section below). In stage (b), r₀ is advanced by pushing the 6th control vertex in the FIFO of r₀. In stage (c), r₁ is advanced by computing its new vertex from the last 4 vertices of r₀ (e.g., by a call to helper function f23, presented later). In stage (d), r₀ is advanced by computing its new vertex from the last 4 vertices of r₁. Note that the 5 points in the FIFO of r₂ have moved by 1 vertex along the final refined curve. In stage (e), r₀ is advanced again by computing its new vertex from the last 3 vertices of r1. In stage (f), r₁ is advanced by computing its new vertex from the last 3 vertices of r₀. In stage (g), r₀ is advanced. In stage (h), r₀ is advanced again. The remaining stages (i) through (o) are analogous to the stages just described.

### Extensions to Surfaces and Animation

The examples discussed so far are two-dimensional, but the techniques disclosed herein can be extended to refine curves in higher dimensions and to refine curves with properties. The ringing approach described above generates points on the subdivided curve one by one. One adaptation defines the trajectory of a moving point or the trajectory of the center of a moving object and animates it. Replacing each control point by a different trajectory defines an animated curve that deforms through time where, at each step of the animation, each control point is advanced by one step along its trajectory, and then the subdivision curve these points define is rendered. This animation approach uses one set of motion-rings per moving control point and one set of display-rings for drawing the current curve at a given time. For example, the third point of each final motion-ring may be used as a control polygon for driving the display-ring and drawing the current curve.

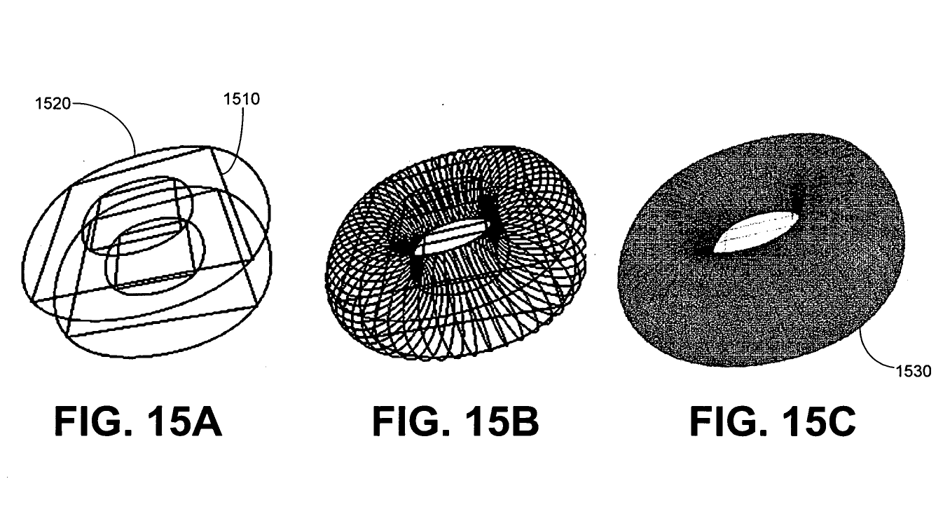

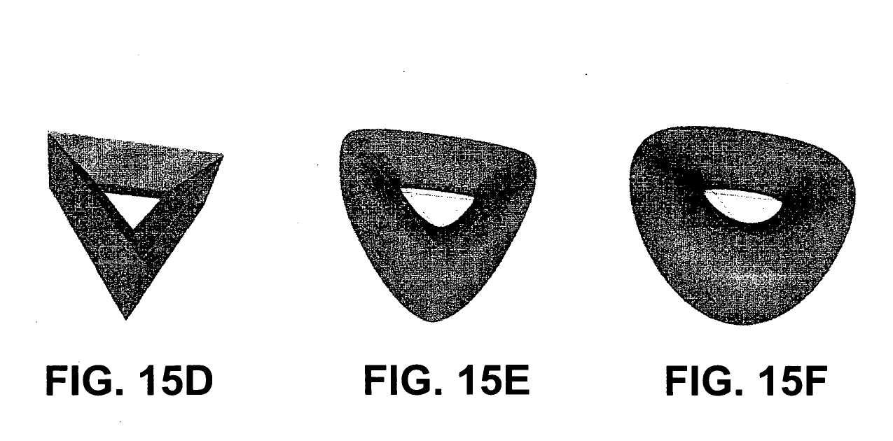

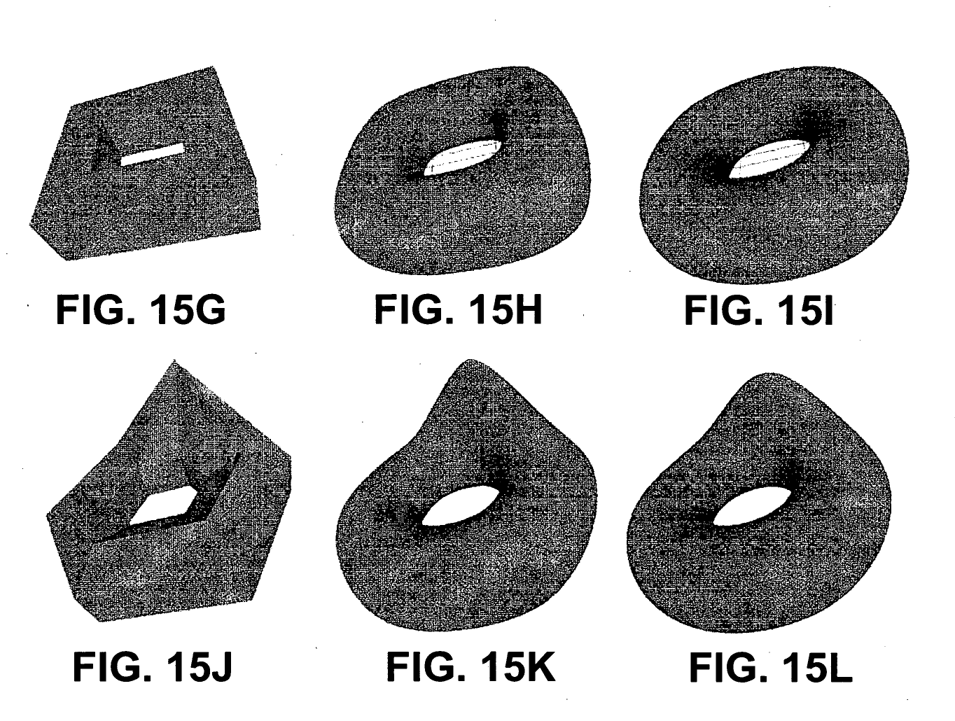

Surfaces are produced as described above, but a second set of display-rings is used, driven using the fourth point (say point D) on each final motion-ring. The two display-rings are driven simultaneously to produce a string of quads along the surface. This technique is illustrated in FIGS. 15A-15L: FIG. 15A shows a torus-like surface defined by 4 control curves (e.g. 1510) with 4 control vertices each. Subdivided versions of these curves are shown as 1520. FIG. 15B shows a transversal curve (1530) defined by each set of 4 corresponding moving control points, one on each trajectory. FIG. 15C shows triangle strips formed by pairs of consecutive transversal curves are shaded (1540). FIGS. 15D, 15E and 15F show the control polyhedron, *J₁, and ⁵J_{12/8} (respectively) for one control mesh. FIGS. 15G, 15H and 15I show the control polyhedron, *J₁, and ⁵J_{12/8} (respectively) for another control mesh. FIGS. 15J, 15K and 15L show the control polyhedron, *J₁, and ⁵J_{12/8} (respectively) for yet another control mesh. The rendering was performed using a footprint of respectively 5, 6, and 8 rings of 5 points each.

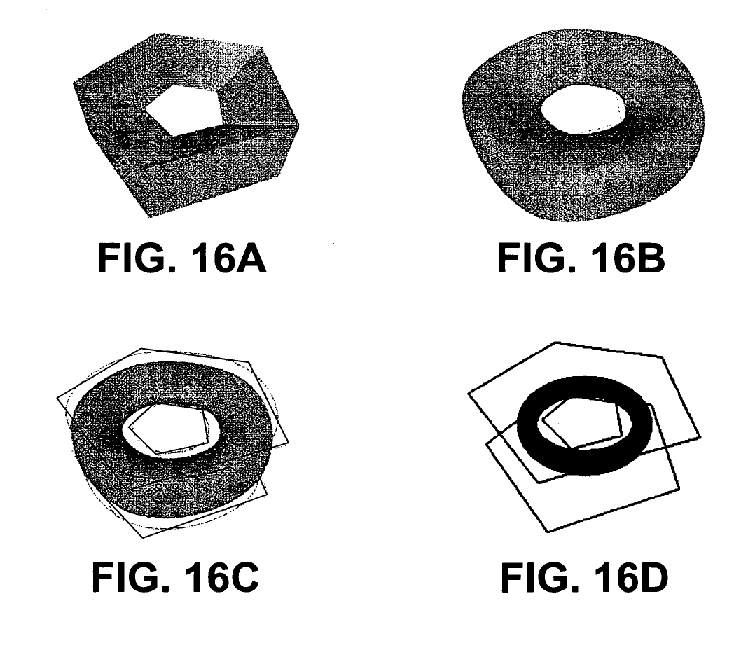

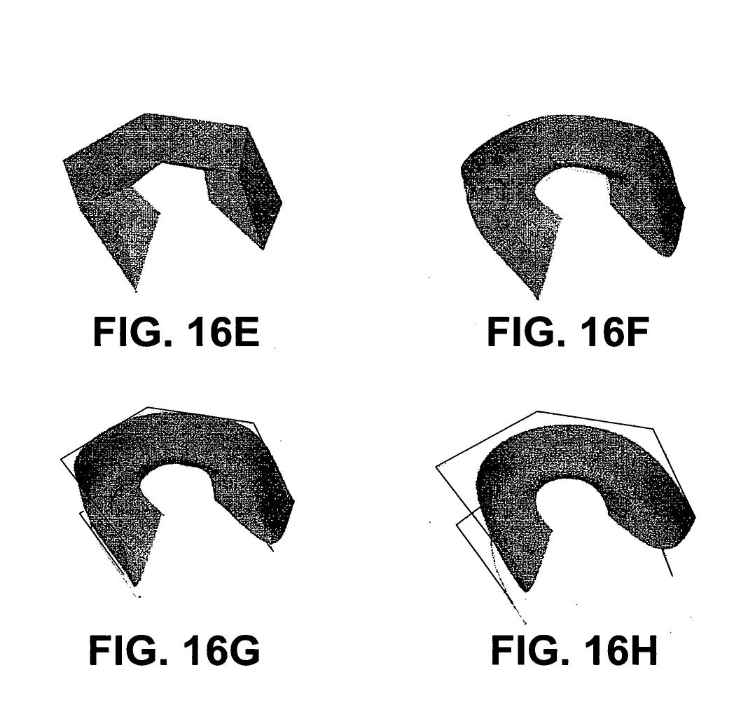

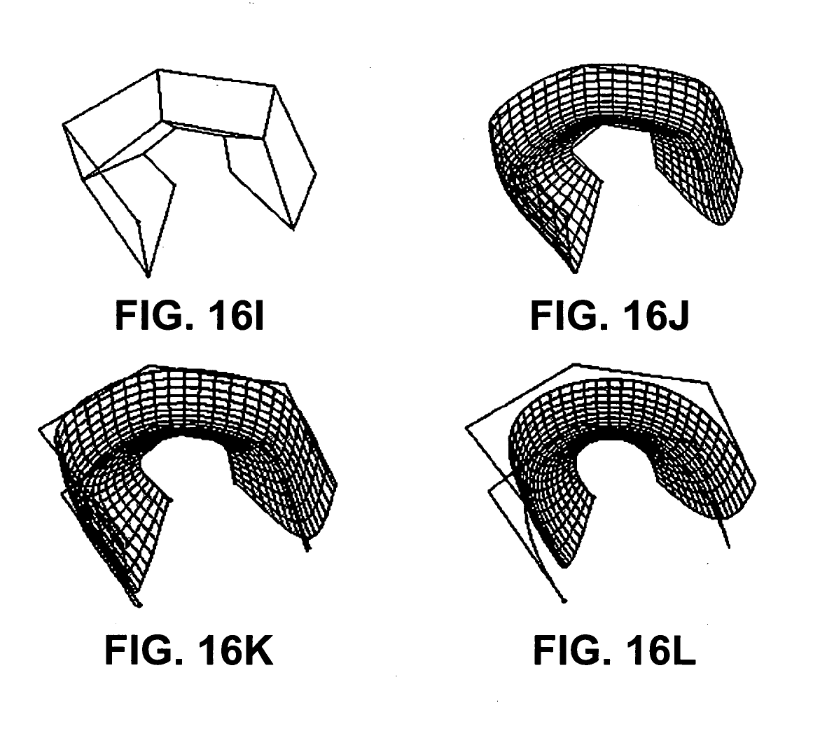

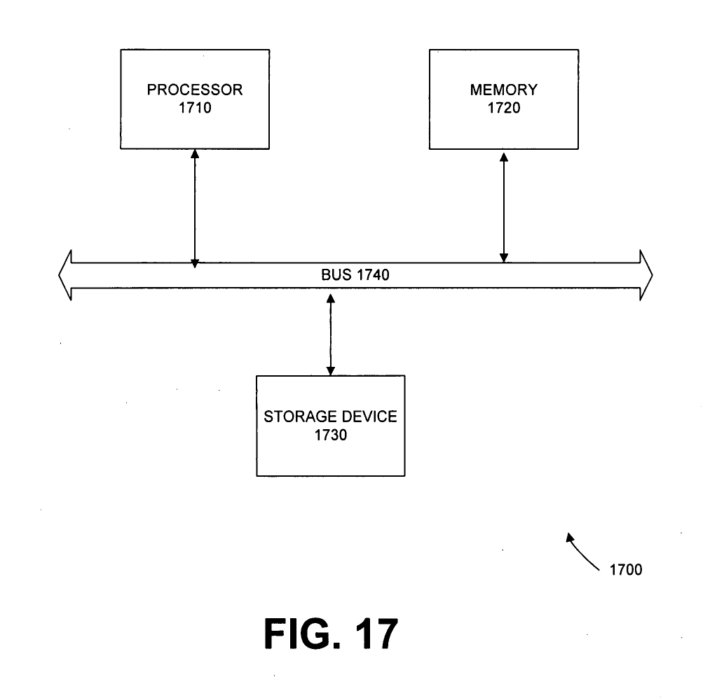

To produce surfaces with borders, automatically adjusted endpoints are added (as explained above in the discussion of extending to open curves) to each motion-ring and to the display-rings and treat them as open-loop curves. FIGS. 16A-16L show this process for various surfaces defined by 3 curves of 5 points each. FIGS. 16A-16D show a closed surface control polyhedron, four-point, Jarek, and quintic B-spline (respectively). FIGS. 16E-16H show the same curves, but with open surfaces and one border. Finally, FIGS. 16I-16L show the same curves, but with quads drawn.

Reproduced below is sample code for implementing the ringing method described above. Although classes are used, an object-oriented language is not required.

class Stepper { // stepper for the rings

| | |
|---|---|
| boolean [ ] B = new boolean [10]; | //Boolean flags and number of recursions |
| int d=0; | |
| Stepper (int pd) {d=pd; this.reset( );}; | |

void reset( ) {for(int i=0; i<d; i++) B[i]=true; d=rec;}
int next( )
{int c=0;
while(B[c]&&(c<d)) {B[c]=false; c++;};

| | |
|---|---|
| B[c]=true; return(c); } | // returns ID of ring that should do a b3 step |
| } | |

int n(int c) {return((c+1)%5);} int p(int c) {return((c+4)%5);} // next and previous in ring
pt l(pt A, float s, pt B) {
return(new pt(A.x+s*(B.x−A.x),A.y+s*(B.y−A.y),A.z+s*(B.z−A.z))); }; // linear interpolation
pt b(pt A, pt B, pt C, float s) {

| | |
|---|---|
| return( I(I(B,s/4.,A),0.5,I(B,s/4.,C))); }; | // tucks in a vertex towards its neighbors |
| pt f(pt A, pt B, pt C, pt D, float s) { | |

return( I(I(A,1.+(1.−s)/8.,B) ,0.5,I(D,1. +(1.−s)/8.,C))); }; // bulges out a mid-edge point
class ring { // ring for traversing refined curves

| | |
|---|---|
| pt[ ] P = new pt[5]; | // a FIFO of 5 points {A,B,C,D,E} |

| | |
|---|---|
| int c=2; | // index of middle point C (rotated at each step to avoid copying points) |

ring ( ) {for (int i=0; i<5; i++) P[i]=new pt(0,0);};

| | |
|---|---|
| void push (pt F) {c=n(c); P[n(n(c))]=F.make( );} | // loads new point and advances index |
| void reset( ) {c=2;}; | |
| pt pt( ) {return(P[c].make( ));} | |

| | |
|---|---|
| pt b1(float s) {pt bb = b( P[p(p(c))],P[p(c)],P[c], s); return(bb); } | // b for second vertex |

pt f12(float s) {pt bb = f(P[p(p(c))], P[p(c)],P[c], P[n(c)], s); return(bb); } // f for second mid-edge

| | |
|---|---|
| pt b2(float s) {pt bb = b(P[p(c)], P[c], P[n(c)], s); return(bb); } | // b for third vertex |

pt f23(float s) {pt bb = f(P[p(c)], P[c], P[n(c)], P[n(n(c))],s); return(bb); } // f for fourth mid-edge

| | |
|---|---|
| pt b3(float s) {pt bb = b(P[c], P[n(c)],P[n(n(c))], s); return(bb); } | // b for fifth vertex |

void derive(ring Q, float a, float b) {c=2; P[0]=Q.b1(a); P[1]=Q.f12(b); P[2]=Q.b2(a);

| | |
|---|---|
| P[3]=Q.f23(b); P[4]=Q.b3(a);} | // makes ring from parent ring |
| void show( ) { | |
| beginShape( ); | |
| int b=p(p(c)); | |

for(int i=0; i<5; i++) {P[b].vert( ); b=n(b);};
endShape( );
for(int i=0; i<5; i++) P[i].show(6);} // show ring
}
class Polyloop { // class of polyloops (closed loop polygon)

| | |
|---|---|
| int vn = 5, cap=5000; | // number of control vertices and the cap on vn |

| | |
|---|---|
| pt[ ] P = new pt [cap]; | // control points |

| | |
|---|---|
| ring [ ] R = new ring[7]; | // 7 rings |

| | |
|---|---|
| int rc; | // counter showing the next control point to load in the top rig |

| | |
|---|---|
| Stepper stepper = new Stepper(rec); | // stepper for knowing which ring to advance |

| | |
|---|---|
| Polyloop ( ) { | // creates empty poly |
| vn=0; | |

for (int i=0; i<cap; i++) P[i]=new pt(0,0);
for(int i=0; i<7; i++) R[i] = new ring( );
}
void pushRing( ) {R[0].push(P[rc]); rc=this.in(rc);} // pushes the next control point to the top ring
void loadRing( ) {
stepper.reset( ); R[0].reset( ); rc=0;
for(int i=0; i<5; i++) {

| | |
|---|---|
| R[0].push(P[rc]); rc=this.in(rc); }; } | // pushes first 5 points to top ring |
| void deriveRings( ) { | |
| R[0].reset( ); | |
| for (int r=1; r<=rec; r++) { | |

| float a=gs, b=gs; | |
|---|---|
| if (r==1) {a=ga; b=gb;}; | |
| R[r].derive(R[r−1],a,b);}; | // derive all other rings |

}

| | |
|---|---|
| void showRing(int r) {R[r].show( );} | // shows 5 points of ring (for demonstration only) |
| void f(int r) { | |
| float a=gs, b=gs; | |
| if (r==1) {a=ga; b=gb;}; | |

| | |
|---|---|
| R[r].push(R[r−1].f23(b));} | // pushes ring r with the f23 of parent ring |
| void b(int r) { | |
| float a=gs, b=gs; | |
| if (r==1) {a=ga; b=gb;}; | |
| R[r].push(R[r−1].b3(a));} | // pushes ring r with the b3 of parent ring |
| pt next( ) { | |
| int level=rec-stepper.next( ); | |

if(level==0) this.pushRing( ); else this.b(level);
for (int r=level+1; r<=rec; r++) this.f(r);

| | |
|---|---|
| return(R[rec].pt( ));} | // advances last ring by one point along curve |
| void showRefined( ) { | |

this.loadRing( ); this.deriveRings( );
beginShape( );
for (int j=0; j<vn*int(pow(2,rec)); j++) this.next( ).vert( );

| | |
|---|---|
| endShape(CLOSE); } | // displays the curve |

FIG. 17 is a hardware block diagram of a general-purpose computer 1700 which can be used to implement various embodiments of the subdivision scheme and the ringing process disclosed herein. Computer 1700 contains a number of components that are well known in the computer arts, including a processor 1710, memory 1720, and storage device 1730. Examples of storage device 1730 include, for example, a hard disk, flash RAM, flash ROM, and EEPROM. These components are coupled via a bus 1740. Memory 1720 contains instructions which, when executed by the processor 1710, implement the subdivision scheme and/or ringing method disclosed herein. Omitted from FIG. 17 are a number of conventional components that are unnecessary to explain the operation of computer 1700.

When implemented in software (e.g., by instructions executing on a processor) the subdivision scheme and/or the ringing process disclosed herein may be embodied in any computer-readable medium for use by or in connection with computer 800, or with any system that can fetch and execute the instructions. In the context of this disclosure, a “computer-readable medium” can be any means that can contain or store the program for use by, or in connection with, an instruction execution system. The computer readable medium can be, for example but not limited to, a system or that is based on electronic, magnetic, optical, electromagnetic, infrared, or semiconductor technology.

Specific examples of a computer-readable medium using electronic technology would include (but are not limited to) the following: random access memory (RAM); read-only memory (ROM); and erasable programmable read-only memory (EPROM or Flash memory). A specific example using magnetic technology includes (but is not limited to) a portable computer diskette. Specific examples using optical technology include (but are not limited to) compact disk (CD) and digital video disk (DVD).

The subdivision scheme and/or the ringing process disclosed herein may also be implemented in hardware, including (but not limited to): a programmable logic device (PLD), programmable gate array (PGA), field programmable gate array (FPGA), an application-specific integrated circuit (ASIC), a system on chip (SoC), and a system in package (SiP). In particular, the subdivision scheme and/or the ringing process disclosed herein may be implemented in hardware by a graphics processor, also known as a graphics processing unit (GPU).

A GPU is a specialized type of microprocessor that is optimized to perform fast rendering of three-dimensional primitive objects such as triangles, quadrilaterals, etc. The primitives are described with vertices, where each vertex has attributes (e.g., color), and textures can be applied to the primitives. The result of the rendering is a two-dimensional array of pixels which appears on a computer display or monitor. In this contemplated embodiment, the subdivision scheme and/or ringing process is implemented by the GPU itself (i.e, in hardware logic) rather than by instructions executing on the GPU (i.e., in software running on the GPU).

Any software components illustrated herein are abstractions chosen to illustrate how functionality is partitioned among components Other divisions of functionality are also possible, and these other possibilities are intended to be within the scope of this disclosure. Furthermore, to the extent that software components are described in terms of specific data structures (e.g., arrays, lists, flags, pointers, collections, etc.), other data structures providing similar functionality can be used instead.

Any software components included herein are described in terms of code and data, rather than with reference to a particular hardware device executing that code. Furthermore, to the extent that system and methods are described in object-oriented terms, there is no requirement that the systems and methods be implemented in an object-oriented language. Rather, the systems and methods can be implemented in any programming language, and executed on any hardware platform.

Any software components referred to herein include executable code that is packaged, for example, as a standalone executable file, a library, a shared library, a loadable module, a driver, or an assembly, as well as interpreted code that is packaged, for example, as a class. In general, the components used by the systems and methods of reducing media stream delay are described herein in terms of code and data, rather than with reference to a particular hardware device executing that code. Furthermore, the systems and methods can be implemented in any programming language, and executed on any hardware platform.

The flow charts, messaging diagrams, state diagrams, and/or data flow diagrams herein provide examples of the operation of systems and methods of reducing media stream delay through independent decoder clocks, according to embodiments disclosed herein. Alternatively, these diagrams may be viewed as depicting actions of an example of a method implemented by independent decoder clocking logic 190. Blocks in these diagrams represent procedures, functions, modules, or portions of code which include one or more executable instructions for implementing logical functions or steps in the process. Alternate implementations are also included within the scope of the disclosure. In these alternate implementations, functions may be executed out of order from that shown or discussed, including substantially concurrently or in reverse order, depending on the functionality involved. The foregoing description has been presented for purposes of illustration and description. It is not intended to be exhaustive or to limit the disclosure to the precise forms disclosed. Obvious modifications or variations are possible in light of the above teachings. The implementations discussed, however, were chosen and described to illustrate the principles of the disclosure and its practical application to thereby enable one of ordinary skill in the art to utilize the disclosure in various implementations and with various modifications as are suited to the particular use contemplated. All such modifications and variation are within the scope of the disclosure as determined by the appended claims when interpreted in accordance with the breadth to which they are fairly and legally entitled.

What is claimed is:

1. A method of rendering a curve from a polygonal control loop ⁰P, the method comprising:
iteratively applying k subdivisions described by Jₛ to a series of polygons starting with ⁰P, where each subdivision is applied to the previous polygon.

2. A computer system for converting a control polygon described by a set of vertices ⁰P to a polygonal curve described by a set of vertices ^{k}P, the device comprising:
memory;
a processor configured by instructions retrieved from the memory to:
initialize by loading a top ring data structure in a series of ring data structures with the first 5 vertices in ⁰P;
compute the first 5 vertices in each of a series of intermediate polygons ¹P to ^{k-1}P and the final polygonal curve ^{k}P using a respective odd or even Jₛ mask, and store each of the computed vertices in an appropriate location in a corresponding one of the remaining ring data structures;
compute the remaining vertices in ^{k}P by recursively performing the compute above, advancing the bottom ring data structure by one vertex, and advancing each successively higher ring data structure such that ring rₖ₋₁ advances one vertex for every 2 vertices advanced in rₖ:

3. A graphics processor unit (GPU) for converting a control polygon described by a set of vertices ⁰P to a polygonal curve described by a set of vertices ^{k}P, the GPU comprising:
logic configured to initialize by loading a top ring data structure in a series of ring data structures with the first 5 vertices in ⁰P;
logic configured to compute the first 5 vertices in each of a series of intermediate polygons ¹P to ^{k-1}P and the final polygonal curve ^{k}P using a respective odd or even Jₛ mask, and store each of the computed vertices in an appropriate location in a corresponding one of the remaining ring data structures;
logic configured to compute the remaining vertices in ^{k}P by recursively performing the compute above, advancing the bottom ring data structure by one vertex, and advancing each successively higher ring data structure such that ring rₖ₋₁ advances one vertex for every 2 vertices advanced in rₖ:
